(19) United States
(12) Patent Application Publication
(10) Pub. No.: US 2007/0272683 A1
(43) Pub. Date: Nov. 29, 2007

(54) MICROWAVE ANTENNA CONFIGURATION, ACCESSORY WITH SUCH A MICROWAVE ANTENNA CONFIGURATION, AND COOKING APPLIANCE WITH AT LEAST ONE SUCH ACCESSORY

(75) Inventor: Peter Kohlstrung, Kaufering (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: TOPINOX SARL, Wittenheim (FR)

(21) Appl. No.: 11/744,092

(22) Filed: May 3, 2007

(30) Foreign Application Priority Data
May 4, 2006 (EP) 06 290 729.0

(51) Int. Cl. H05B 6/74

(52) U.S. Cl. 219/746

(57) ABSTRACT

An antenna configuration for a cooking appliance with a cooking chamber, including at least one accessory for introducing at least two cooking product carriers for the treatment of cooking products on at least two treatment levels. The accessory carrying multiple antennae. The cooking appliance having an equipment chamber or technical chamber separated from the cooking chamber having at least one microwave source, whereby the antennae are fed from the microwave source with microwaves with wavelength λ through a system of lines of the accessory. At least one antenna is arranged per treatment level and each treatment level is arranged in a resonant body for the microwaves. The resonant body defined by a cooking product carrier and the cooking chamber or between two cooking product carriers. The antennae comprise detuned λ/4 rods to provide essentially the same microwave energy to each treatment level.

### BACKGROUND

1. Field of the Invention

The invention concerns an antenna configuration for a cooking appliance with a cooking chamber, in which at least one accessory is arranged at least some of the time for the introduction of at least two cooking product carriers into the cooking chamber for the purpose of treatment of cooking products on the cooking product carriers on at least two treatment levels, each treatment level being defined by a cooking product carrier, wherein the at least one accessory carries a multiple number of antennae, and the cooking appliance includes an equipment chamber or technical chamber separated from the cooking chamber in which at least one microwave source is arranged, whereby the antennae can be fed with microwaves from the microwave source with wavelength λ through a system of lines, which is comprised by the accessory; at least one antenna is being arranged per treatment level for radiation of microwaves and each treatment level is being arranged in a resonant body for the microwaves radiated into the cooking chamber, the resonant body being defined by a cooking product carrier and the cooking chamber or between two cooking product carriers; as well as an accessory with such an antenna structure and a cooking appliance with at least one such accessory.

2. Related Technology

A generic cooking appliance with a microwave-generating device is described in the not pre-published EP 05026912, namely using an antenna structure that is also generic, most of which extends into a generic accessory of the cooking appliance, such as an oven rack, a hinging rack, etc. that can be arranged in the cooking chamber of the cooking appliance. This antenna structure permits a specific coupling-out of microwaves in various treatment levels for cooking products in the cooking chamber, without details of the same having been disclosed. However, a coupling and conduction system from a microwave guide outside the cooking chamber to a microwave guide inside the cooking chamber is described. The microwave guides can be designed as coaxial lines, whereby the microwave guides in the cooking chamber may comprise a U-shaped carrier of the accessory as an outer conductor of the coaxial line in which an inner conductor runs, and through which microwaves can be guided from the microwave source to all antennae of an antenna structure.

U.S. Pat. No. 5,334,403 discloses a device for drying, regenerating and defrosting, which has several treatment levels, whereby each treatment level has a movable magnetron assigned to it and which has at least one antenna. The at least one antenna can be placed in variable positions between insertion tracks above and respectively below a cooking product in a treatment level, which leads to a complicated and costly structure.

Furthermore, a microwave cooking appliance is known from US 2004/0004074 in which a cooking chamber has several microwave coupling-out locations that are fed by a microwave source. However, this microwave appliance has only one cooking level.

A disadvantage of the prior art described above is that microwave energy cannot be fed simply, cost-effectively, and uniformly to a multiple of cooking product levels or treatment levels. For example, when a multiple number of magnetrons are used, much space is taken up in the equipment chamber or technical chamber of an appliance. Moreover, synchronization of the magnetrons is extremely complicated, especially when uniform input of microwave energy into the cooking product is desired at various treatment levels, since the microwave radiation of different antennae influence each other mutually, and for example, may weaken or possibly extinguish.

### GENERAL DESCRIPTION

Therefore, the task of the present invention is to further develop the generic antenna structure for a cooking device in such a way that the disadvantages of the prior art are overcome. Especially, an antenna structure is to be provided for a cooking appliance that makes uniform energy input into the cooking product possible on various treatment levels. Moreover, the antenna structure is designed to be as simple and space-saving as possible, save cost, simplify handling, and reduce the occurrence of breakdowns. Finally, the coupling-out of the microwaves occurs as close to a cooking product as possible, in order to be able to treat the cooking product in a targeted manner.

This task is solved according to the invention by the fact that the antennae are designed as detuned λ/4 rods, in order to provide essentially the same amount of microwave energy to the cooking products in each treatment level.

Hereby, it is preferred that the detuning of the antennae that radiate in different resonant bodies and can be fed by the microwave source is adjusted to the distances of the particular resonant body from the microwave source and/or to the dimensions of the particular resonant body.

Hereby, it can be provided that the larger the resonant body, the more strongly the corresponding antenna will be detuned, and/or the more antennae are placed between this antenna and the microwave source, the less an antenna is detuned.

With the invention it is also proposed that the degree of detuning of an antenna be adjusted over its length and/or its diameter relative to an optimum λ/4 antenna, whereby preferably in a case with a multiple number of antennae that can be fed through a microwave source and are arranged in different resonant bodies with essentially the same dimensions, the antenna that is arranged in the resonant body farthest from the microwave source most nearly approaches an optimum λ/4 antenna.

Furthermore, it can be provided that each antenna is assigned a recess in a waveguide of the system of lines and that the degree of detuning of an antenna is adjusted by the area of the recess.

Preferred embodiments according to the invention are characterized by the fact that the waveguide has, at least in the cooking chamber, a coaxial line with an inner conductor, especially in the form of a round conductor, and an outer conductor arranged around it, preferably having a U-shaped cross-section, which is preferably provided by the accessory.

The invention also concerns an accessory for a cooking appliance with an antenna configuration according to the invention, in the form of an oven rack, a mobile oven rack, or a hinging rack.

Hereby, it can be provided that the distances of the cooking product carriers from one another are essentially the same and that the uppermost cooking product carrier in the cooking chamber has a distance to the cooking chamber ceiling which is larger than the distances of the cooking product carriers to one another, whereby preferably the length of the antennae fed by a microwave source and assigned to different cooking product carriers increases with the distance to the microwave source, except for the antenna assigned to the uppermost cooking product carrier.

With the invention it is also proposed that each antenna is distanced from the cooking product carrier assigned to it in order to avoid short circuits and arcing, whereby preferably the distances of the antennae to the particular cooking product carriers are essentially equal.

Embodiments of the invention are characterized by two essentially vertical carriers in the cooking chamber, at least one horizontal carrier running between the vertical carriers and tracks for supporting the cooking product carrier, which run essentially parallel to the horizontal carrier between the vertical carriers.

Hereby, it can be provided that each waveguide in the cooking chamber comprises a coaxial line, the grounded outer conductor of which is formed by the carriers in which the inner conductors run.

It is additionally proposed hereby with the invention that the antennae always extend essentially perpendicularly from an inner conductor within a vertical carrier and essentially parallel to the cooking product carriers and/or tracks in the direction of a recess, which is located in the outer conductor belonging to the inner conductor or extends beyond.

Furthermore, it can be provided that the microwaves in the cooking chamber be fed into the accessory from below.

It is also proposed according to the invention that the accessory be separable and connectable to a microwave source through a coupling piece for microwaves.

Hereby, it can be provided that between the inner conductor in a first vertical carrier and the coupling piece, a first shunt is provided and/or between the inner conductor in the second vertical carrier and the coupling piece, a second shunt is provided, whereby preferably the inner conductor in the horizontal carrier is arranged between the first and second shunt.

With the invention it is also proposed that the coupling piece is connected to one of the two vertical carriers, whereby preferably the same microwave energy can be introduced to each waveguide of the two vertical carriers.

Furthermore, it can be provided that at least one end of at least one vertical carrier is equipped with a microwave-reflecting end piece, whereby preferably each of the two vertical carriers have such a reflecting end piece at each of their ends, so that standing waves develop in the coaxial lines of the vertical carrier.

Hereby, it can be provided that, between the two reflecting end pieces of each vertical carrier, at least one shunt, and a multiple number of antennae are arranged.

Finally, according to the invention, a cooking appliance is also proposed with a cooking chamber that is delineated by four side walls, a cooking chamber ceiling and a cooking chamber floor and in which an accessory according to the invention is arranged in the vicinity of each of the two opposite side walls.

Thus, the invention is based on the surprising finding that the antenna configuration according to the invention makes it possible to radiate through a multiple number of antennae microwaves of wavelength λ uniformly into different treatment levels positioned in the cooking chamber, arranged on top of one another by inserts. By a detuning of the antennae, the energy radiated through the resonant bodies formed by the insert is adjusted, reducing the field strength at each coupling-out point. Hereby, according to the invention, it is possible that microwaves are fed only at one location into an accessory which is necessary anyway for the cooking of foods, in order to realize a space-saving and cost-effective uniform exposure of foods to microwave energy in each insert. Special material savings and space savings are obtained according to the invention when the antenna structure, together with the conduction system, is integrated at least partly in carriers, tracks, and/or posts of the accessory, as is already described in the non-pre-published EP 05026912.

The detuning of the antennae of the individual inserts can be achieved by the fact that the length of the antennae deviate from the optimum length of a λ/4 antenna. Hereby, for reasons of space-saving, it is especially advantageous to detune the antennae by shortening them in comparison to the optimum λ/4 geometry. In order to obtain as uniform charging of the individual inserts as possible, or better stated, of the foods arranged on them, with microwave energy, the energy radiated at the different antenna positions, which causes a reduction of the field strength in the waveguide of the accessory, must be considered in such a way that the same amount of energy can be radiated from the nth antenna only when a larger percentage of the remaining residual field strength of the same is coupled out. This can be achieved by having the length of the n^{th} antenna somewhat longer than the length of the (n−1)^{st} antenna, and thus being closer to the optimum antenna geometry of λ/4.

However, the same effect can also be achieved by increasing the thickness of the antennae. A lowering of the radiated energy can also be achieved by reducing a recess in the microwave (outer) waveguide around the antenna. All these effects are used according to the invention for influencing the energy of the microwaves radiated from an antenna.

Also, according to the invention, the dimension of each resonant body in the cooking chamber, which is especially determined by the distance between two inserts, must be taken into consideration. Namely, if the distance between two inserts is large, more modes and polarizations of the microwave radiated from an antenna can develop in the resonant body delineated by the two inserts, so that more energy is radiated from the antenna onto the food preferably arranged on a baking sheet in the resonant body between two inserts. This is taken into consideration according to the invention by shortening the length of the antennae in the larger resonant bodies, that is, detuning them more, than the remaining antennae.

Other characteristics and advantages of the invention follow from the detailed description of preferred embodiments of the invention given in detail below with the aid of schematic drawings. The following are shown.

### BRIEF DESCRIPTION OF THE DRAWINGS

FIG. 1 is a perspective representation of an accessory for a cooking appliance without insert tracks;

FIG. 2a is a longitudinal side sectional view of a section of the accessory of FIG. 1, but with one insert track, to illustrate a system of lines of an antenna structure according to the invention, and

FIG. 2b is a cross-sectional view of the system of lines of antenna structure of FIG. 2a, rotated by 90° around a horizontal line relative to the view shown in FIG. 2a.

### DETAILED DESCRIPTION

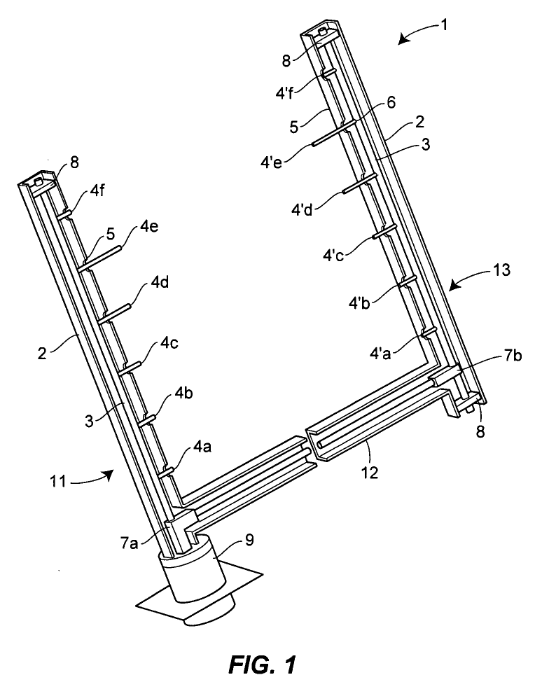

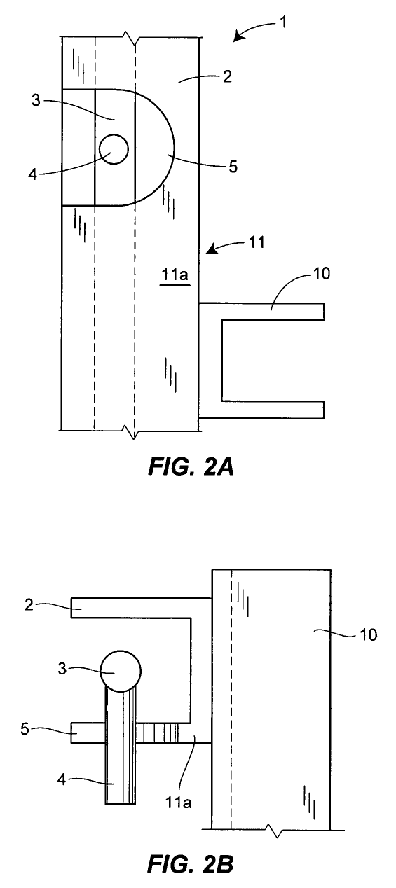

An accessory 1 according to the invention in the form of a hinging rack with insert tracks 10 for baking sheets (not shown) or similar cooking product carriers as well as with an antenna structure 4 to be used in a cooking appliance (not shown) is represented in FIGS. 1 to 2b. The antenna structure 4 comprises a multiple number of antennae 4a-4f, 4′a-4′f, to which microwave energy is introduced for radiation of microwaves at a wavelength λ will be described.

Through a coupling piece 9, which is described in the not-pre-published DE 10 2006 007 734.2, microwaves with wavelength λ are sent from a microwave source (not shown) to a shunt 7. At the shunt 7, the corresponding microwave energy is divided into two equal parts and then further conducted through coaxial lines. In each coaxial line, the corresponding microwaves travel along a grounded outer conductor 2 and an inner conductor 3 running therein to arrive at connections 6 of the inner conductor 3 to antenna 4a-4f, 4′a-4′f, which, depending on size, extend from the inner conductor 3 to or beyond a recess 5 of the outer conductor 2 and into the cooking chamber of the cooking appliance.

Each of the inner conductors 3 is hereby introduced into one of two 3 carriers 11, 13 that are vertical in the built-in situation, or to posts or horizontal carriers 12 or tracks of the accessory, which at the same time represent the corresponding outer conductor 2 and are designed as round conductors in order to cooperate with the carriers 11-13 to provide a coaxial line as already described in EP 05026912. Hereby, the two vertical carriers 11, 13 are provided, each of which represent a grounded screening and serve to carry tracks 10, one of which is shown in FIGS. 2a and 2b. The tracks 10 are arranged between the antennae 4 as well as parallel to them, from a vertical carrier 11 to the other vertical carrier 13, in order to hold baking sheets in different treatment levels in the cooking chamber of the cooking appliance. The baking sheets arranged on top of each other define resonant bodies into which the microwave energy is radiated. In the built-in situation, a horizontal carrier 12 is provided between the two vertical carriers 11, 13, namely to connect the two vertical carriers 11, 13, which again represent grounded outer conductors 2 for inner conductors 3 guided therein. In order to have to connect only one of the carriers 11-13 to the microwave source through the coupling piece 9, the inner conductors 3 of the horizontal carrier 12 extends between the two shunts 7. In other words, microwave energy arrives from the coupling piece 9 into a first shunt 7a and from there into the coaxial line of the first vertical carrier 11 as well as to the coaxial line of the horizontal carrier 12. Then, through the horizontal carrier 12 and the other shunt 7b, microwave energy arrives again into the coaxial line of the second vertical carrier 13. In the end region of each of the two vertical carriers 11, 13, a reflecting end piece 8 is provided, which serves to produce a standing wave in the particular coaxial line.

If microwave energy arrives at a connection 6 of the inner conductor 3 to an antenna 4, a part of this energy is radiated for the radiation of microwaves along the antenna 4 and through the corresponding recess 5 in the outer conductor 2 and into the cooking chamber between two baking sheets or between the floor of the cooking chamber and a baking sheet or between a baking sheet and the ceiling of the cooking chamber. The fraction of energy radiated in this way is determined by the length and the diameter of antenna 4, as well as by the size of the recess 5 in outer conductor 2. Thereby, for example, in the case of six antennae 4a-4f, 4′a-4′f per vertical carrier 11, 13, only ⅙ of the energy of the microwave is coupled out at the lowest antenna 4a and 4′a, respectively, of each vertical carrier 11, 13. The rest of the microwave energy is conducted further to the next antenna 4b and 4′b, respectively, in each vertical carrier 11, 13, which is a little longer than the lowermost antenna 4a, 4′a, so that at this point, ⅕ of the remaining energy of the microwaves can be radiated.

In this way, the energy of the microwaves radiated from the second antennae 4b and 4′b is exactly the same magnitude as the energy radiated from the first antennae 4a and 4′a. Since a standing wave develops in the coaxial lines 2, 3 at each antenna 4a-4f, 4′a-4′f, ⅙ of the microwave energy introduced to each vertical carrier 11,13 can be radiated due to the lengthening of the antennae 4a-4e, 4′a- 4′e from the bottom toward the top in the cooking chamber, except for the uppermost antennae 4f and 4′f. Because of the large distance between the uppermost inserts or baking sheet and the ceiling of the cooking chamber, which exceeds the distance between two inserts or cooking sheets, a large number of microwave modes of different polarizations are allowed to impinge on the uppermost baking sheet and thus on the food arranged on it (not shown), for which reason the uppermost antennae 4f, 4′f are shortened. The second highest antennae 4e, 4′e, preferably represent essentially λ/4 antennae. In other words, the microwave radiation that can be applied to a cooking product on a baking sheet between two inserts, is essentially the same for each baking sheet, that is for each treatment level.

FIGS. 2a and 2b show a section of the left vertical carrier 11 of the accessory 1 of FIG. 1 with a top view onto a U-shaped recess 5 and an antenna 4, which extends vertically from the inner conductor 3. The U-shaped recesses 5 extend in a side wall 11a of the U-shaped carriers 11 to their free edge, while tracks 10 are arranged on the other edge parallel to the antennae 4.

In another embodiment of the accessory according to the invention, the carriers 11-13 are designed as tubes, so that a waveguide structure is produced such that the inner conductor 3 can be omitted. The coupling-out of microwaves in such an arrangement can be achieved by recesses in the tubes, whereby the size of the recesses is adjusted to the sequence and the size of the distances between the inserts.

An accessory according to the invention can be removed from the cooking chamber and incorporated into it simply, by inserting the coupling piece 9 into a sleeve provided for this purpose in the floor of the cooking chamber (not shown). The coupling-in of the microwaves in this case is achieved preferably capacitively and/or inductively, so that contamination does not lead to incorrect functioning. Such a coupling piece is described in the not-pre-published DE 10 2006 007 734.2.

Advantageously, a cooking appliance according to the invention has two antenna structures, namely on two opposite sides of a cooking chamber, but the two can be connected through a single coupling and feed-through system to a single microwave source. The division of the energy can be achieved by shunts 7 and/or at least one additional coupling piece 9.

The characteristics of the invention disclosed in the above specification, in the claims and in the drawings can be essential both individually as well as in any arbitrary combination for the realization of the invention in its various embodiments.

1. Antenna configuration for a cooking appliance with a cooking chamber in which at least one accessory is arranged for the introduction of at least two cooking product carriers into the cooking chamber for the purpose of treatment of cooking products on the cooking product carriers on at least two treatment levels, each treatment level defined by a cooking product carrier, the at least one accessory carrying a multiple number of antennae, the cooking appliance having an equipment chamber or technical chamber separated from the cooking chamber, in which at least one microwave source is arranged, whereby the antennae can be fed with microwaves with wavelength λ through a system of lines, which is comprised by the accessory; at least one antenna being arranged per treatment level for radiation of microwaves and each treatment level being arranged in a resonant body for the microwaves radiated into the cooking chamber, the resonant body being defined between a cooking product carrier and one of the cooking chamber ceiling and another cooking product carrier, the antennae being designed as detuned λ/4 rods in order to provide essentially the same microwave energy to the cooking products in each treatment level.

2. Antenna configuration according to claim 1, wherein detuning of the antennae, which are fed by the microwave source and which radiate in different resonant bodies, is adjusted to the distances between the particular resonant bodies from at least one of the microwave source and the dimensions of the particular resonant body.

3. Antenna configuration according to claim 2, wherein the larger a resonant body the more strongly the corresponding antenna is detuned.

4. Antenna configuration according to claim 1, wherein the degree of the detuning of an antenna is adjusted via at least one of the length and the diameter of the antenna relative to an optimum λ/4 antenna.

5. Antenna configuration according to claim 1, wherein each antenna has a recess in a waveguide of the system of lines assigned to it and the degree of detuning of an antenna is adjusted by the area of the recess.

6. Antenna configuration according to claim 5, wherein the waveguide comprises, at least in the cooking chamber, a coaxial line with an inner conductor, and an outer conductor arranged around the inner conductor.

7. Accessory for a cooking appliance with an antenna configuration according to claim 1, the accessory comprising one of an oven rack, a mobile oven rack, and a hinging rack.

8. Accessory according to claim 7, wherein the distances between the cooking product carriers are essentially of the same magnitude, and the cooking product carrier arranged uppermost in the cooking chamber has a distance to the ceiling of the cooking chamber that is greater than the distances between the cooking product carriers, whereby preferably the length of the antennae fed from a microwave source and assigned to different cooking product carriers increases with the distance to the microwave source, except for the antenna assigned to the uppermost cooking product carrier.

9. Accessory according to claim 7, wherein each antenna is distanced from the cooking product carrier assigned to it for the purpose of avoiding short circuits and arcing.

10. Accessory according to claim 7, comprising two essentially vertical carriers in the cooking chamber, at least one horizontal carrier arranged between vertical carriers and tracks to support the cooking product carrier, the tracks essentially parallel to the horizontal carrier between the vertical carriers.

11. Accessory according to claim 10, wherein each antenna has a waveguide and each waveguide in the cooking chamber comprises a coaxial line, the grounded outer conductor of which is formed by the carriers in which the inner conductors run.

12. Accessory according to claim 11, wherein the antennae each extend essentially perpendicularly from an inner conductor within a vertical carrier and essentially parallel to at least one of the cooking product carriers and the tracks in the direction of a recess which is located in the outer conductor belonging to the inner conductor.

13. Accessory according to claim 7, wherein the microwaves in the cooking chamber are led from below into the accessory.

14. Accessory according to claim 7, wherein the accessory can be separated from and connected to a microwave source through a coupling piece for microwaves.

15. Accessory according to claim 14, wherein at least one of a first shunt is arranged between the inner conductor in a first vertical carrier and the coupling piece and a second shunt is arranged between the inner conductor in the second vertical carrier and the coupling piece.

16. Accessory according to claim 14, wherein the coupling piece is connected to one of both vertical carriers.

17. Accessory according to claim 7, wherein at least one end of at least one vertical carrier is equipped with a microwave-reflecting end piece.

18. Accessory according to claim 17, wherein between the two reflecting end pieces of each vertical carrier at least one shunt and a multiple number of antennae are arranged.

19. Cooking appliance with a cooking chamber that is delineated by four side walls, a cooking chamber ceiling, and a cooking chamber floor, and in which, in the vicinity to each of two opposite side walls, an accessory according to claims 7 is arranged.

20. Antenna configuration according to claim 2, wherein an antenna is less detuned the more antennae are placed between the antenna and the microwave source.

21. Antenna configuration according to claim 4, wherein in the case of a multiple number of antennae, which can be fed from a microwave source and arranged in different resonant bodies with essentially the same dimensions, the antenna that is arranged in the resonant body farthest from the microwave source comes closest to an optimum λ/4 antenna.

22. Antenna configuration according to claim 6, wherein the inner conductor comprises a round conductor.

23. Antenna configuration according to claim 6, wherein the outer conductor comprises a U-shaped cross-section.

24. Antenna configuration according to claim 23, wherein the outer conductor is provided by the accessory.

25. Accessory according to claim 9, wherein the distances between the antennae and the particular cooking product carriers are essentially of the same magnitude.

26. Accessory according to claim 12, wherein the antennae extend beyond the recess in the outer conductor belonging to the inner conductor.

27. Accessory according to claim 15, wherein the inner conductor in the horizontal carrier is arranged between the first and second shunts.

28. Accessory according to claim 16, wherein essentially the same microwave energy is introduced to each waveguide of the two vertical carriers.

29. Accessory according to claim 17, wherein the two vertical carriers have a reflecting end piece on each of their ends such that standing waves develop in the coaxial lines of the vertical carriers.
